(19) United States
(12) Patent Application Publication
(10) Pub. No.: US 2005/0095448 A1
(43) Pub. Date: May 5, 2005

(54) Layer incorporating particles with a high dielectric constant

(76) Inventors: Howard Edan Katz, Summit, NJ (US); Ashok J. Maliakal, Westfield, NJ (US)

Correspondence Address: Lucent Technologies Inc.;Docket Administrator (Room 3J-219), 101 Crawfords Corner Road, Holmdel, NJ, 07733-3030, US

(21) Appl. No.: 10/700,651

(22) Filed: Nov. 4, 2003

(51) Int. Cl. B05D 1/12; B32B 9/00

(52) U.S. Cl. 428/689; 427/180; 428/323

(57) ABSTRACT

An apparatus includes a substrate having a surface and a dielectric layer located on the surface. The dielectric layer includes a distribution of particles. Each particle includes a particle core and a polymer shell chemically bonded to and located around the associated particle core. Each particle core includes a material having a dielectric constant of about fifteen or more. The dielectric layer has a dielectric constant of seven or more.

The U.S. Government has a paid-up license in this invention and the right in limited circumstances to require the patent owner to license others on reasonable terms as provided for by the terms of Advanced Technology Program Cooperative Agreement No. 70NANB2H3032 awarded by the National Institute of Standards and Technology.

### BACKGROUND OF THE INVENTION

1. Field of the Invention

This invention relates to dielectric layers.

2. Discussion of the Related Art

A large variety of inorganic compounds are known to produce bulk dielectrics. Some of these compounds produce homogeneous bulk materials whose dielectric constants have small values. For example, silicon dioxide is typically homogeneous and has a dielectric constant with a small value of about 4. Some of the above compounds produce inhomogeneous bulk materials whose dielectric constants have large values. For example, titanium dioxide is typically particulate and has a dielectric constant with a large value of about 80 or more.

A large variety of organic compounds are also known to produce bulk dielectrics. For example, many organic polymers produce homogenous bulk materials. These materials typically also have dielectric constants with small values.

### SUMMARY

Various embodiments provide homogeneous dielectric layers whose dielectric constants have large values. The dielectric layers include a homogeneous distribution of particle cores and of polymer that surrounds and physically stabilizes the individual particles. The particle cores are made of one or more materials whose dielectric constant(s) have large value(s). The particle cores occupy a large fraction of the total volume so that the dielectric layers have dielectric constants with large values even though the polymer does not have a large dielectric constant. The polymer makes such dielectric layers more flexible and less brittle so that they are easier to handle than many layers of conventional inorganic dielectrics.

Some embodiments provide an apparatus that includes a substrate having a surface and a dielectric layer located on the surface. The dielectric layer includes a distribution of particles. Each particle has a particle core and a polymer shell chemically bonded to and located around the associated particle core. Each particle core includes a material whose dielectric constant has a value of about fifteen or more. The dielectric layer has a dielectric constant with a value of seven or more.

Other embodiments provide an apparatus that includes a substrate with a surface and a dielectric layer located on the surface. The dielectric layer includes a distribution of particles. Each particle has a particle core and polymer chains chemically bonded to an outside surface of the particle core. The polymer chains may form shells around individual ones of the particle cores. Each particle core includes a material with a dielectric constant of about fifteen or more. The particle cores occupy, at least, 20 percent of the volume of the dielectric layer.

Some embodiments provide methods for fabricating dielectric layers that are substantially homogeneous and have dielectric constants with relatively large values. One such method includes a step of depositing particles on a surface of a substrate to form a dielectric layer on said surface. Each particle has a particle core and a polymer shell chemically bonded to and located around the associated particle core. Each particle core includes a material whose dielectric constant is about fifteen or more. The formed dielectric layer has a dielectric constant of seven or more.

### BRIEF DESCRIPTION OF THE DRAWINGS

FIG. 1 is a cross-sectional view of a portion of a dielectric layer formed of particle cores and shells located around individual ones of the particle cores;

FIG. 2 is a flow chart that illustrates a method of fabricating the dielectric layer of FIG. 1;

FIG. 3 shows atom transfer radical polymerization initiator (ATRPI) moieties that are capable of initiating controlled radical polymerization reactions;

FIG. 4 illustrates a reaction that functionalizes a TiO₂ particle core by bonding ATRPI moieties to the surface of the particle core, and

FIG. 5 shows exemplary reactive monomers for forming the polymer chains of polymer shells shown in FIG. 1 via controlled radical polymerization reactions.

In the figures and text, like reference numbers refer to functionally similar features.

### DETAILED DESCRIPTION OF THE EMBODIMENTS

Various embodiments are described more fully with reference to the accompanying drawings and detailed description. This invention may, however, be embodied in various forms and is not limited to the embodiments described herein.

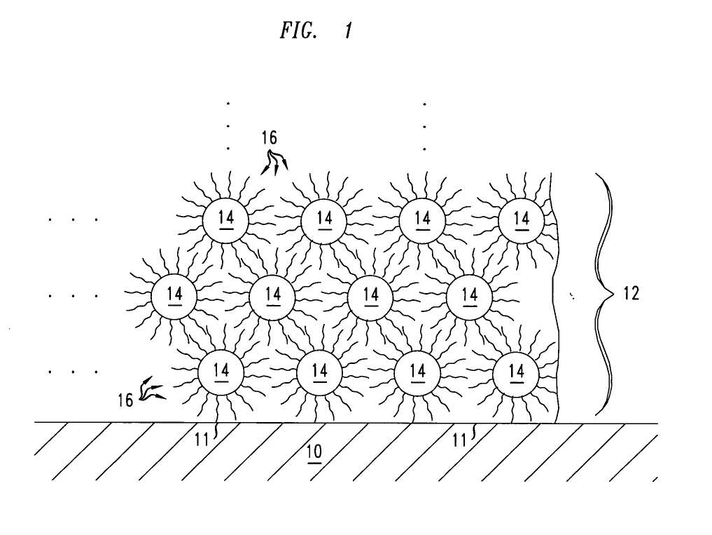

FIG. 1 shows a portion of an apparatus 8 that includes a substrate 10 and a dielectric layer 12 located on a surface 11 of the substrate 10. The substrate 10 may be a metal, an organic or inorganic dielectric, or an organic or inorganic semiconductor. The dielectric layer 10 includes a substantially homogeneous distribution of particle cores 14. Each particle core 14 is a microscopic inorganic object. The particle cores 14 are however, large enough to include both surface atoms and interior atoms, i.e., atoms completely surrounded by other atoms of the same particle core 14. The interior atoms form in the particle cores 14 a phase whose properties are similar to those of bulk objects of the same material. Each particle core 14 is also surrounded by a shell of an organic polymer, which is chemically bonded to the associated particle core 14. While the polymer shells may or may not provide a fully dense covering around the surface of the associated particle cores 14, the polymer shells form a matrix between the particle cores 14 of the dielectric layer 12. The polymer shells prevent particles cores 14 from aggregating and phase separating, electrically insulate particle cores 14 from each other, and fill holes between the particle cores 14 so that the resulting dielectric layer 12 has smooth surfaces. The dielectric layer 12 has a thickness sufficient to ensure the absence of through holes passing from one surface to the opposite surface. Exemplary dielectric layers 12 have a thickness between about 20 nm and about 2 micrometers (μm) and are typically less than about 1 μm thick.

In the dielectric layer 12, the dielectric constant has a relatively large value of seven or more. Thus, the dielectric constant of the dielectric layer 12 is larger than that of a conventional inorganic dielectric such as silica glass. In the dielectric layer 12, the large value of the dielectric constant results from two properties. First, the particle cores 14 are substantially formed of material(s) whose dielectric constant(s), ε, have large value(s), i.e., ε's greater than or equal to about 15 in a particle core 14. The particle cores 14 are substantially formed of materials such as metal oxides and semiconductors. Exemplary materials include titanium oxide, TiO₂, whose ε is greater than 80; barium titanate; strontium titanate; and germanium whose ε is near 16. Second, the particle cores 14 occupy a large fraction of the total volume of the dielectric layer 12. Since a large fraction of the total layer volume is the high dielectric constant material(s) of the particle cores 14, the dielectric layer 12 itself has a large dielectric constant.

The particle cores 14 occupy at least 20% of the total volume of dielectric layer 12 and typically occupy 30-60% or more. In embodiments where the particle cores 14 occupy only about 20-40% of the total volume, polymer shells occupy a large fraction of the total volume thereby producing a more flexible dielectric layer 12. In embodiments where the particle cores 14 occupy 50-60% or more of the total volume, the particle cores 14 may be fabricated of a larger variety of materials. Due to the high volume fraction, particle cores 14 made of materials with only moderately high dielectric constants still produce a large dielectric constant for the dielectric layer 12.

In an exemplary dielectric layer 12, the particle cores 14 are roughly identical TiO₂ spheres, and the ratio of the sphere radius to the center-to-center separation between adjacent spheres is about 5:12. Thus, the associated polymer shells have a thickness of about ⅕ times the sphere radius or more. Polymer chains 16 of the shells may be longer than ⅕ times the sphere radius, because the polymer chains 16 from adjacent polymer shells may inter-digitate in the dielectric layer 12. For typical random packing configurations, the TiO₂ particles 14 occupy about 50% of the total volume of such a layer. Thus, the dielectric layer 12 will have a dielectric constant with a value that is much larger than 7 even if the polymer of the shells only has a dielectric constant of about 4, i.e., near that of silica glasses. Such an exemplary dielectric layer 12 has a much larger dielectric constant than many conventional organic and inorganic dielectrics, e.g., SiO₂.

In the dielectric layer 12, the particle cores 14 have linear dimensions of less than 1 μm, i.e., the particle cores 14 are microscopic particles. The particle cores 14 may have a variety of shapes, e.g., spherical, elongated, or irregularly shaped, and a variety of sizes. Exemplary particle cores 14 of TiO₂ are spheres whose radii are about to 10-40 nanometers (nm). The various particle cores 14 of the same dielectric layer 12 may have a distribution of difference sizes and/or different shapes.

In the dielectric layer 12, each polymer shell includes polymer chains 16 that chemically bond at one end to the outer surface of the associated particle core 14. The chemical bonds may be strong covalent bonds or only moderately strong chemical bonds. The chemical bonds have dissociation energies of at least 20 kilocalories (Kcal) per mole and typically have dissociation energies of about 40-100 Kcal per mole. Exemplary polymer chains 16 are formed of monomers such as styrenes, acrylates, and alkyl-substituted styrenes or acrylates; strained cycloalkanes that polymerize by ring-opening metathesis; epoxides that polymerize by ring opening;. and/or are formed copolymers of such monomers. The polymer chains 16 of one shell may have a distribution of lengths or be of substantially the same length. The polymer chains 16 of a shell may form a fully densified coating around the associated particle core 14 or may form a much less dense coating around the associated particle core 14. The polymer chains 16 of the various shells are sufficiently dense to inhibit aggregation or phase separation of the particle cores 14 and to electrically insulate adjacent particle cores 14 from each other in the dielectric layer 12. The polymer chains 16 of the shells also provide a matrix that aids in producing smooth thin films by filling in voids between the particle cores 14. The polymer chains 16 of adjacent shells also partially inter-digitate.

In some embodiments, inter-digitated polymer chains 16 from adjacent shells interact rather strongly via attractive van der Waals forces, physical hooking, entanglement, and/or chemical cross linking. Such interactions between the polymer chains 16 of different shells can physically stabilize the entire matrix of the dielectric layer 12.

The interactions between polymer chains 16 of different shells provide structural integrity to the dielectric layer 12. In particular, the matrix of polymer chains 16 is a flexible composition, because the polymer chains 16 are themselves flexible. The interactions between the polymer chains 16 of different shells also make the matrix less susceptible to cracking or crumbling. Interactions between the polymer chains 16 of different shells also structurally fix the spatial distribution of the particle cores 14 so that the cores 14 do not substantially move or aggregate in response to moderate applied electric fields. The inter-digitations of the polymer chains 16 also aid to homogenize the density of the particle cores 14 during formation of the dielectric layer 12. Finally, the polymer chains 16 at least partially fill voids thereby producing a smoother top surface for the dielectric layer 12. Smooth top surfaces are often advantageous for subsequently growing organic semiconductor thereon.

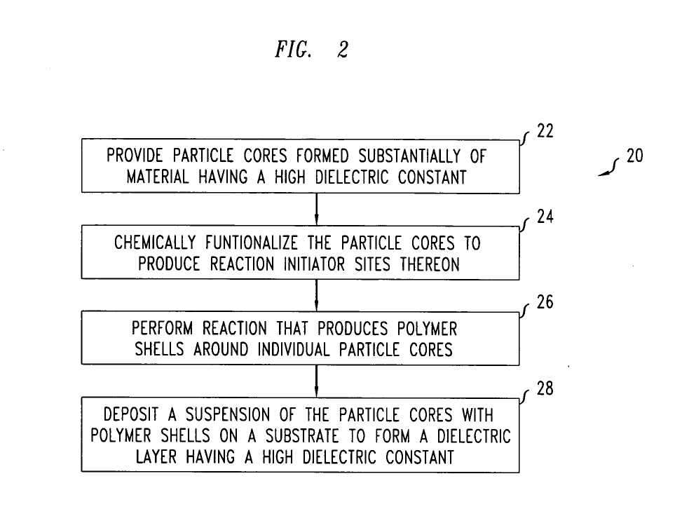

FIG. 2 illustrates a method 20 for fabricating a dielectric layer whose dielectric constant is larger than seven, e.g., dielectric layer 12 of FIG. 1.

The method 20 includes providing a plurality of microscopic particle cores that are formed substantially of high dielectric constant material (step 22). The particle cores are formed principally of material(s) having a dielectric constant of 15 or more and often a dielectric constant of 40 or more. Exemplary materials for the particle cores include metal oxides such as TiO₂ and semiconductors such as germanium. TiO₂ particles of microscopic size are commercially available from Nanoproducts Corporation, 14330 Long Peak Court, Longmont, Colo. 80504 USA as 20%-30% dispersion by weight in methyl isobutyl ketone (MIK) or tetrahydrofuran (THF).

The method 20 includes producing chemically functionalized particle cores for the particles cores of step 22 (step 24). The functionalized particle cores have a density of initiator sites for a selected shell-forming reaction on exterior surfaces of the particle cores. One method for providing the functionalization is based on atom transfer radical polymerization initiator (ATRPI) moieties. An exemplary chemical functionalizing step includes performing a surface chemical reaction on said particle cores to covalently bond ATRPI moieties to the exterior surfaces thereof.

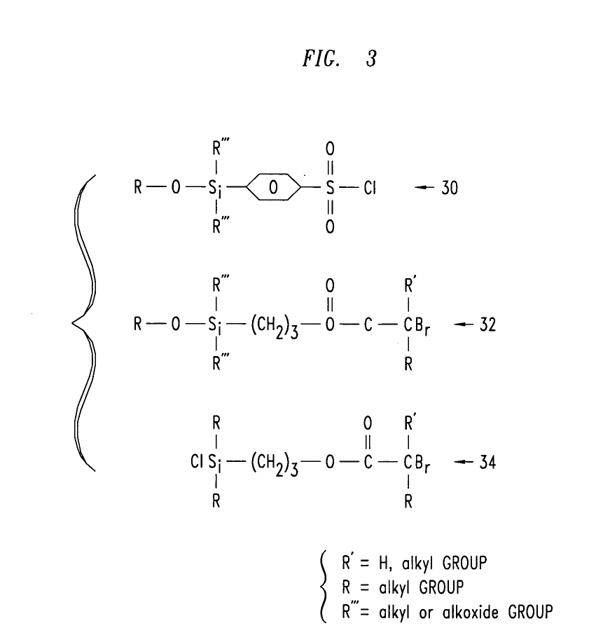

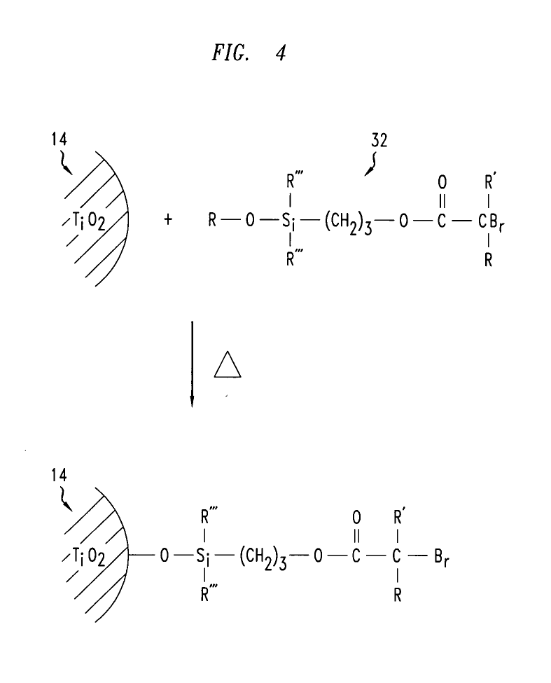

FIG. 3 shows exemplary ATRPI moieties 30, 32, 34 that are appropriate for initiating controlled radical polymerization reactions. An exemplary surface chemical reaction for covalently bonding the ATRPI moiety 32 to a spherical TiO₂ particle core is illustrated in FIG. 4. The chemical reaction proceeds upon raising the temperature of a suspension of the particle cores in the presence of the ATRPI moiety 32. Typical temperatures for the functionalization reaction involve temperatures of around 85° C.

The method 20 includes performing a reaction that fabricates dielectric polymer shells around individual ones of the functionalized particle cores (step 26). The reaction may grow polymer chains from the initiator sites located on the particle cores. Alternatively, the reaction may cause pre-formed polymer chains to chemically bond to the initiator sites on the surfaces of the particle cores. Finally, in some embodiments, step 24 is absent and step 26 involves chemically bonding preformed polymer chains directly to the surfaces of the particle cores.

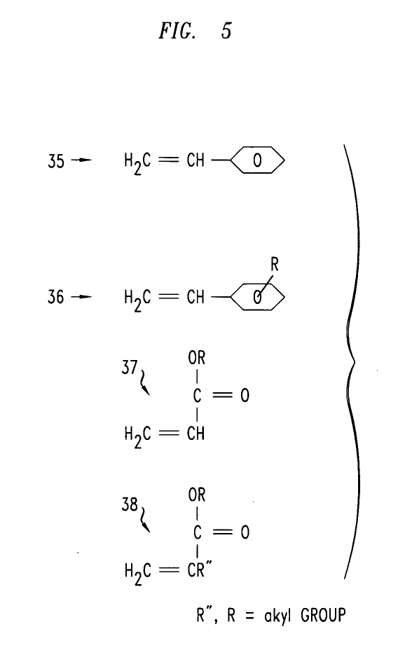

In various embodiments, performing the reaction to fabricate the dielectric polymer shells at step 26 includes stopping the reaction when the polymer shells have obtained a pre-selected thickness. Exemplary embodiments based on chain growth reactions exploit controlled radical polymerization reactions in which ATRPI moieties on the exterior surfaces of the particle cores initiate the polymerization additions of reactive monomers thereto. For controlled radical polymerization reactions initiated by the ATRPI moieties 30, 32, 34 of FIG. 3, exemplary reactive monomers include styrene 35, alkyl substituted styrene 36, acrylate 37, and alkylacrylates 38 as shown in FIG. 5. Controlled radical polymerization reactions may be timed so that the resulting polymer shells have a pre-selected thickness.

The method 20 also includes depositing a suspension of the particles formed at step 26 on a surface of a substrate to produce a dielectric layer with a high dielectric constant (step 28). Exemplary depositing steps include spin casting, drop casting, or printing a suspension of the particles in a solvent such as THF, benzene, toluene, xylene, chlorobenzene, or chloroform onto a planar surface of a substrate. Then, evaporating the solvent from the deposited suspension to form the dielectric layer. In the resulting dielectric layer, a high volume fraction is occupied by the particle cores due to the pre-selection of the thickness for the polymer shells. In particular, the polymer shells are thin enough so that a typical random packing of the particle cores occupies a larger fraction of the layer's volume. The volume fraction occupied by the particle cores is pre-selected to be large enough to ensure that the final dielectric layer will have a dielectric constant of seven or more. In exemplary dielectric layers, the particle cores occupy at least 20% of the total volume of the layer, and typically occupy 30% or more, 35% or more, or 40%-50% or more of said total volume. Thus, the resulting dielectric layer has a dielectric constant that is usually much larger than those of inorganic dielectrics such as silica glass and of conventional organic polymeric dielectrics.

In some embodiments, the thickness of the polymer shell is selected to be thin enough so that the final dielectric layer has a dielectric constant of 15 or more.

In some embodiments, forming step 28 also includes cross linking polymer chains of adjacent shells to produce a cross linked solid. In such embodiments, a cross linking agent such as a vinyl acrylate and a photo initiator are mixed into the suspension of the particles from step 26 prior the casting or printing. Also, the cast or printed layer is cured with ultraviolet light or heat cure to stimulate chemical cross linking of a portion of the polymer chains from adjacent shells. Conditions for such cross linking reactions are well known to those of skill in the art for various cross linking agents.

### EXAMPLES

In some exemplary embodiments, method 20 uses spherical TiO₂ particles with radii of about 10-15 nm or larger as the particle cores at step 22. The spherical TiO₂ particles are prepared for use in layer forming step 28 as described below.

First, a surface-functionalization reaction forms polymerization initiator sites on surfaces of the spherical TiO₂ particles. In preparation for performing the surface-functionalization, the TiO₂ particles are mixed with tetrahydrofuran (THF) to form a suspension that includes about 10 to 30 weight percent (wt %) TiO₂. Next, (3-(2-bromoisobutyryl)propyl)dimethylethoxysilane (BDS), i.e., an ATRPI, is mixed into the suspension so that the resulting mixture includes about 1-2 mole equivalents of BIDS for each mole of surface bonding sites on the TiO₂ particles. Next, the suspension is heated to boiling for about 12 hours to start the surface-functionalizing reaction. Typical heating temperatures are between 50° C.-100° C., e.g., about 85° C. The heating stimulates a reaction that chemically bonds the BIDS moieties to sites on the exterior surface of the TiO₂ particles. The reaction is stopped by lowering the temperature of the suspension. Then, hexane is added to the suspension, and a centrifugation is performed to remove the surface-functionalized TiO₂ particles from the solvents. Next, a wash treatment is performed to remove excess polymerization initiator, i.e., to remove initiator net chemically bonded to the TiO₂ particles. The treatment involves repeatedly suspending the TiO₂ particles in hexane and then, centrifuging the suspension to isolate the TiO₂ particles. Typically, about 5 cycles of the treatment is sufficient to remove the unbonded ATRPI. Finally, an evaporation step eliminates the hexane thereby producing a powder of surface-functionalized TiO₂ particles.

Next, a polymerization reaction grows styrene-based or acrylate-based polymer shells on the functionalized surfaces of the TiO₂ particles.

One process for carrying out the styrene-based polymerization reaction includes the following steps.

First, a round bottomed flask is loaded with about 133 grams (g) of the functionalized TiO₂ particles, about 74.2 milligrams (mg) of CuBr, about 0.398 grams of 4,4′-di-(5-(5-nonyl)-2,2′-bipyridine (dNbipy), and a stirring bar. The amount of CuBr catalyst may be increased by a factor of about 1-4 to speed up the reaction. The dNbipy forms soluble complexes with copper ions of the CuBr catalyst and is available from Reilly Industries, Inc., Reilly Industries, Inc., 300 N. Meridian Street, Suite 1500, Indianapolis, Ind. 46204-1763 USA.

Next, the flask is attached to a vacuum manifold and a solution of about 7.64 g of liquid styrene and a small volume percent of dodecane, e.g., about 1 volume %, is added to the flask via a syringe.

Next, about three cycles of a freeze/pump/thaw/and degassing treatment is performed to de-oxygenate the mixture in the flask, i.e., by replacing oxygen with nitrogen. Such de-oxygenating treatments are well known to those of skill in the art. After three cycles of the treatment, the remaining oxygen should not be sufficient to interfere with subsequent polymerization reaction.

Next, the liquid in the flask is stirred to form a uniform suspension of the functionalized TiO₂ particles.

Then, the temperature of the suspension is raised to a temperature in the range of 100° C. to 130° C., e.g., 110° C., to start the styrene-based polymerization reaction. When the polymer shells have the desired thickness, the temperature of the suspension is lowered to stop the polymerization reaction. The progress of the reaction may be monitored via gas chromatography measurements of the ratio of moles of the reactive styrene to moles of the unreactive dodecane in the mixture. From the disappearance of styrene and an estimate of the number of polymerization sites on the TiO₂ particles, lengths of polymer chains and the thickness of the polymer shells can be estimated and thus, a point for stopping the reaction can be determined. For spherical TiO₂ particles with 30 nm radii, the polymerization reaction is stopped when the polymer shells have a thickness of about 2 nm to about 10 nm. For example, in an 8 nm thick shell, the polymer chains have about 100 styrene monomers.

Finally, TiO₂ particle cores with associated shells are separated from the polymerization reaction mixture. To separate the particles, methanol is mixed into the suspension, because particle cores with associated polymer shells have low solubilities in methanol. When methanol is added, the TiO₂ particle cores with associated shells precipitate out of the mixture. Then, a filtration removes the particles having cores and shells from the remaining solvent.

An alternate process for carrying out the acrylate-based polymerization includes the following steps.

First, a flask is loaded with about 267 grams (g) of the functionalized TiO₂ particles, about 8.5 mg of CuBr, about 2.5 mg of CuBr₂, about 0.582 grams of dNbipy, and a stirring bar. The amount of CuBr catalyst may be increased to speed up the subsequent polymerization reaction.

Next, the flask is connected to a vacuum manifold, and a syringe is used to add to the flask a solution of substituted acrylate monomers in p-xylene or TBF, e.g., a 10 molar solution. Exemplary aryl and/or alkyl substituted acrylates have an alkyl chain with about 1-15 carbon atoms.

Next, several cycles of the above-described freeze/pump/thaw and degassing treatment are performed to de-oxygenate the closed flask. Then, the mixture is stirred to form a homogeneous suspension of the functionalized TiO₂ particles.

Next, the temperature of the suspension is raised to a value in the range of 80° C. to 110° C., e.g., about 90° C., thereby starting the polymerization reaction. Progress of the polymerization reaction is monitored via gas chromatography analyses as already described. When the reaction has produced polymer shells of the desired thickness, the suspension's temperature is lowered to stop further polymerization.

Finally, the TiO₂ particle cores with acrylate-based shells are removed from the reaction mixture via precipitation and filtration as already described with respect to the particle cores having styrene-based shells.

The TiO₂ particles with styrene- or acrylate-based polymer shells can be used in above step 28 to form a dielectric layer having a large dielectric constant.

Other embodiments of the invention will be apparent to those skilled in the art in light of the specification, drawings, and claims of this application.

1. A method, comprising:
depositing particles on a surface of a substrate to form a dielectric layer on said surface, each particle having a particle core and a polymer shell that is chemically bonded to and located around the associated particle core, each particle core comprising a material whose dielectric constant has a value of about fifteen or more; and
wherein the formed dielectric layer has a dielectric constant of seven or more.

2. The method of claim 1, wherein the depositing includes applying a suspension of the particles in a solvent onto the surface of a substrate.

3. The method of claim 1, wherein at least 20 percent of the volume of the formed dielectric layer is occupied by said particle cores.

4. The method of claim 1, wherein at least 35 percent of the volume of the formed dielectric layer is occupied by said particle cores.

5. The method of claim 3, wherein the dielectric layer has a dielectric constant of at least 15 or more.

6. The method of claim 1, wherein each polymer shell comprises polymer chains, each chain having one end covalently bonded to the particle core associated to the same shell.

7. The method of claim 3, wherein the material of each particle core comprises one of a metal oxide and a semiconductor.

8. The method of claim 6, further comprising forming said polymer shells by growing said polymer chains from initiator sites that are located on the particle cores.

9. The method of claim 8, wherein said initiator sites include atom transfer radical polymerization initiator moieties that are chemically bonded to surfaces of said particle cores.

10. The method of claim 1, wherein the depositing further comprises casting or spin coating a liquid on said surface, the liquid comprising a suspension of said particles.

11. An apparatus, comprising:
a substrate having a surface; and
a dielectric layer comprising a distribution of particles, the layer being located on said surface and having a dielectric constant of seven or more; and
wherein each particle has a particle core and a polymer shell that is chemically bonded to and located around the associated particle core, each particle core comprising a material whose dielectric constant is about fifteen or more.

12. The apparatus of claim 11, wherein at least 20 percent of the volume of the dielectric layer is occupied by said particle cores.

13. The apparatus of claim 11, wherein at least 35 percent of the volume of the dielectric layer is occupied by said particle cores.

14. The apparatus of claim 12, wherein the dielectric layer has a dielectric constant of 15 or more.

15. The apparatus of claim 11, wherein each polymer shell comprises a plurality of polymer chains, each chain having one end covalently bonded to the particle core associated to the same polymer shell.

16. The apparatus of claim 11, wherein the material of each particle core comprises one of a metal oxide and a semiconductor.

17. An apparatus, comprising:
a substrate having a surface; and
a dielectric layer comprising a distribution of particles and being located on said surface; and
wherein each particle has a particle core and a plurality of polymer chains chemically bonded to an exterior surface of the particle core, each particle core comprising a material whose dielectric constant has a value of about fifteen or more; and
wherein at least twenty percent of the volume of the dielectric layer is occupied by said particle cores.

18. The apparatus of claim 17, wherein the material of each particle core comprises one of a metal oxide and a semiconductor.

19. The apparatus of claim 17, wherein a portion of the polymer chains that are bonded to different particle cores are one of inter-digitated, entangled, and chemically cross linked.
